(19) United States
(12) Patent Application Publication
(10) Pub. No.: US 2026/0176493 A1
(43) Pub. Date: Jun. 25, 2026

(54) COATING COMPOSITION FOR FOODSTUFFS

(71) Applicant: SAVEGGY AB, Lund (SE)

(72) Inventors: Vahid SOHRABPOUR, MALMÖ (SE); Arash FAYYAZI, LUND (SE); Pirjo WIENA, LUND (SE)

(21) Appl. No.: 19/126,364

(22) PCT Filed: Nov. 20, 2023
(86) PCT No.: PCT/SE2023/051167

§ 371 Date: May 1, 2025

(30) Foreign Application Priority Data
Nov. 28, 2022 (SE) 2251378-2
May 5, 2023 (SE) 2350549-8

(51) Int. Cl. C09D 175/04; A23L 19/18; A23L 33/105; C09D 7/61; C09D 167/00; C11C 3/10

(52) U.S. Cl. CPC C09D 175/04; A23L 19/18; A23L 33/105; C09D 7/61; C09D 167/00; C11C 3/10

(57) ABSTRACT

The present invention describes a coating composition intended for coating of foodstuffs, wherein the coating composition comprises at least one saturated lipid component and an emulsifying agent, and wherein the emulsifying agent comprises oat oil or a derivative of oat oil, preferably the foodstuff being a vegetable or fruit.

### FIELD OF THE INVENTION

The present invention relates to a coating composition for foodstuffs.

### TECHNICAL BACKGROUND

Coating compositions for foodstuffs are known. For instance, in WO2009/143552 A1 there is disclosed a coating composition comprising up to 97 wt. % of a hydrogenated triglyceride that has a melting point of greater than 23° C., up to 10 wt. % of hardened castor oil and wherein the coating composition comprises less than 1 wt. % water.

The present invention is directed to providing an improved coating composition for foodstuffs, which coating composition is edible and which has improved protection capabilities for foodstuffs, especially for foodstuffs containing a substantial amount of water.

### SUMMARY OF THE INVENTION

The stated purpose above is achieved by a coating composition intended for coating of foodstuffs, wherein the coating composition comprises at least one saturated lipid component and an emulsifying agent, and wherein the emulsifying agent comprises oat oil or a derivative of oat oil, preferably the foodstuff being a vegetable or fruit.

In this regard it should be noted that there are existing emulsions comprising oat oil. For instance, in WO 2021/094531 A1 there is disclosed an emulsion comprising an oat oil comprising 8 wt. % or more of ceramides and glycolipids, and optionally at least one polyol and/or a native or modified carbohydrate. The coating composition according to the present invention, however, comprises both at least one saturated lipid component, suitably chosen from C8:0-C18:0, such as at least one edible oil component, e.g. a hydrogenated rapeseed (canola or lobra versions also embodied according to the present invention), and an emulsifying agent comprising oat oil or a derivative of oat oil to provide for the right type of chemical and physical properties, such as e.g. coating handling properties and protection properties.

The coating composition according to the present invention is especially suitable for coating foodstuffs, such as fruits or vegetables, with a comparatively high aqueous content, e.g. cucumbers (Cucumis sativus) with a high water content, egg plants and bell peppers. It should, however, be noted that the coating composition according to the present invention can be applied to other foodstuffs also, such as to meet products, cookies, chocolate, bread etc.

Furthermore, the coating composition according to the present invention has multi-functionality. From one perspective this may understood from analyzing the actions of the emulsifying agent used in the coating composition. The emulsifying agent functions both as an active protection of the foodstuff being coated, but also acts as an emulsifier ensuring a coating that has the right properties for enabling handling and coating of an item. Moreover, it may also have other benefits, such as extending the shelf life of products being coated, preventing oxidation, maintaining a desirable texture, etc. The active protection provided by the coating composition according to the present invention prevents water loss, has an antioxidant, anti-microbial property and provides a form of mechanical protection of the object being coated, such as a cucumber.

In this regard it should be noted that there are existing emulsions comprising oat oil. For instance, in WO 2021/094531 A1 there is disclosed an emulsion comprising an oat oil comprising 8 wt. % or more of ceramides and glycolipids, and optionally at least one polyol and/or a native or modified carbohydrate. The coating composition according to the present invention, however, comprises both one saturated lipid component, such as at least one edible oil component, and an emulsifying agent comprising oat oil to provide for the right type of chemical and physical properties, such as e.g. coating handling properties and protection properties.

### SPECIFIC EMBODIMENTS OF THE INVENTION

Below some specific embodiments of the present invention are provided and discussed further.

The combination of at least one saturated lipid component, suitably chosen from C8:0-C18:0, and an emulsifying agent comprising oat oil or a derivative of oat oil provides for the foundation of the coating composition according to the present invention. According to one specific embodiment, said at least one lipid component is a saturated rapeseed lipid component, suitably a fully hydrogenated lipid component. Some examples will be provided below.

In line with the above is achieved by a coating composition intended for coating of foodstuffs, wherein the coating composition comprises
at least one saturated lipid component chosen from C8:0-C18:0. preferably chosen from C10:0-C18:0; and
an emulsifying agent comprising oat oil or a derivative of oat oil, preferably the foodstuff being a vegetable or fruit.

To combine different oil components in the coating composition according to the present invention may be performed to provide some further beneficial properties for certain technical applications. To give one example, certain oil components may be included to provide stronger protection properties. Examples are saturated coconut oil or rapeseed oil which may be included to provide certain beneficial advantages. Also the combination is possible. Another example is coconut oil which may be included to provide certain beneficial advantages. To give another example, further mentioned below, when an edible wax is included in the composition according to the present invention, coconut oil softens this component and makes it easier to work with when heated up.

It should be noted that also other oils are possible to include in the coating composition according to the present invention as complementary components to the saturated lipid component and oat oil. Examples are olive oil, corn oil and cotton oil. These may function as improvers for certain functions, for taste reasons, etc, etc. Furthermore, several oil types may be combined in a coating composition according to the present invention. Moreover, one or several oil types, such as coconut oil and one other, may be combined with another lipid component, such as edible wax, e.g. carnauba wax, beeswax or candelilla wax.

Also other additional components may be included in the coating composition according to the present invention. In some cases, one or more of these additional components have functional features. In line with this, according to one embodiment, the coating composition comprises an edible wax component. According to another embodiment of the present invention, the coating composition comprises at least one edible polysaccharide, cellulose or a protein.

According to yet another embodiment of the present invention, the coating composition comprises a fermented component, preferably a lactic fermented component, more preferably a fermented cucumber juice. Such an additional component may be provided in the composition to provide antibacterial properties.

Furthermore, according to yet another embodiment of the present invention, the coating composition may comprise at least one resin component, gum component, rubber component, and/or polymer component, such as a hydrocolloid polymer, or a combination thereof. One suitable example is natural gums, such as Arabic gum.

Also the content levels and type of components have importance in relation to the present invention.

According to one embodiment, the coating composition comprises at least 50 wt. % of saturated fatty acids, monoglycerides, diglycerides and/or triglycerides from C8:0-C18:0, or a combination thereof, measured of the total weight of the lipid content, preferably at least 65 wt. %, more preferably at least 80 wt. % of saturated fatty acids, monoglycerides, diglycerides and/or triglycerides from C8:0-C18:0, or a combination thereof, measured of the total weight of the lipid content. According to yet another embodiment, said at least one saturated lipid component is a hydrogenated prior unsaturated lipid component, preferably a hydrogenated prior unsaturated lipid component chosen from C8:0-C18:0. Moreover, according to one specific embodiment, the coating composition comprises at least 50 wt. % saturated fatty acids from C16:0-C18:0, preferably at least 80 wt. %, measured of the total weight of the lipid content. Furthermore, according to one embodiment, the coating composition comprises at least 50 wt. % saturated fatty acids from C18:0, preferably at least 80 wt. %, measured of the total weight of the lipid content. Moreover, suitably, the composition comprises a dry matter level in a range of 10-50%.

According to one specific embodiment, the composition comprises oat oil or a derivative of oat oil in a range of 1-25 wt. %, preferably in a range of 1-20 wt. %, more preferably in a range of 1.5-14 wt. %, more preferably in a range of 2-10 wt. %. In relation to the above it may be mentioned that the content of oat oil or a derivative of oat oil should be high enough to provide for emulsifying effect, however not too high so that coating functionalities may be impaired.

Moreover, suitably the lipid component is based on saturated rapeseed oil, preferably fully hydrogenated rapeseed oil.

According to yet another embodiment, the lipid content is at least 15 wt. % of the coating composition and wherein the coating composition contains maximum 80 wt. % water. Moreover, according to one embodiment, the lipid content is at least 20 wt. % of the coating composition, preferably at least 25 wt. % of the coating composition, more preferably at least 30 wt. % of the coating composition, preferably the coating composition contains maximum 75 wt. % water, more preferably the coating composition contains maximum 70 wt. % water, more preferably the coating composition contains maximum 65 wt. % water, more preferably the coating composition contains maximum 60 wt. % water, most preferably the coating composition contains maximum 55 wt. % water.

In relation to the above it should be mentioned that the coating of the present invention may comprise different types of lipid components in addition to the oat oil and saturated lipid component, such as olive oil, corn oil, sunflower oil, coconut oil, or a mixture thereof.

Furthermore, and as said above, the coating composition may comprise an edible wax component. In line with this, according to one embodiment of the present invention, the edible wax component is carnauba wax, beeswax, candelilla wax, canola wax, shellac or a microcrystalline wax component, or a combination thereof, preferably in a range of 5-60 wt. %, more preferably in a range of 10-60 wt. %, more preferably in a range of 5-40 wt. %, more preferably in a range of 10-40 wt. %, more preferably in a range of 15-30 wt. %. Furthermore, according to another embodiment, the coating composition comprises oat oil or a derivative thereof in a range of 1-20 wt. %, a wax in a range of 15-50 wt. % and coconut oil in a range of 0.1-30 wt. %. Preferably the wax is an edible wax.

The coating composition according to the present invention may be provided in different forms. According to one embodiment, there is provided a coating composition according to the present invention, in the form of a liquid, semi-liquid, spray or dipping. A spray or a dipping is preferred alternatives according to the present invention.

Moreover, according to yet another embodiment of the present invention there is provided a foodstuff, preferably a vegetable or fruit, coated with a coating composition according to the present invention.

According to one embodiment, the foodstuff according to the present invention exhibits maximum 6% weight loss, preferably maximum 3% weight loss, more preferably maximum 2% weight loss, when measured after 7 days at room temperature.

As hinted above, the foodstuff being coated by a coating composition according to the present invention suitably is a vegetable or fruit with a high liquid content. According to one embodiment, the foodstuff is a vegetable or fruit, preferably a vegetable or fruit containing more that 60% water, more preferably a cucumber.

There are also other parameters of interest in relation to the present invention. One such is the thickness of the coating composition when being applied on the foodstuff. According to one embodiment, the thickness of the coating composition is in a range of 0.01-30 μm, preferably in a range of 0.01-10 μm.

Furthermore, the present invention also describes a method for the production of a coating composition according to the present invention. In line with this, according to one embodiment, there is provided a method involving producing a coating composition according to the present invention, said method comprising
mixing components;
heating the mixture, preferably to a temperature of at least 40° C.; and
dispersing.

The present invention also provides a method for the production of a coated foodstuff. According to one embodiment, the present invention provides a method for producing a foodstuff according to the present invention, wherein the method involves applying a coating composition according to the present invention onto the surface of the foodstuff at a temperature in a range of 0-40° C. to provide a coated foodstuff and then drying the coated foodstuff.

### Examples and Trials

One coating composition according to the present invention has been evaluated based on different parameters according to below, and has also further been compared with other alternatives used on the market today.

### Materials

The following alternatives were tested:
a) Uncoated cucumber (called uncoated control below);
b) Cucumber coated with plastic material being a shrink film intended for cucumber (Microperforated LDPE Cucumber Shrink Film);
c) A cucumber coated with a coating according to one embodiment of the present invention, said coating comprising fully hydrogenated rapeseed (canola) fat (65 wt. % of the total lipid content), oat oil (26 wt. % of the total lipid content) and coconut oil (9 wt. % of the total lipid content).

### Methods

The parameters evaluated were the following:
Weight loss. This involves a comparison of weight in day 1 and the coming measurement days. Presentation is made in %. It may be noted that one of the most limiting factors when it comes to shelf life of cucumbers is the loss of water. Loss of water will result in shriveled skin, softer texture and less crunchiness. Coated cucumbers are therefore weighed on a regular basis (Usually after they have been coated and then after 3, 7 and 14 days) and compared to uncoated to see to what extent the coating helps with preventing water loss.
Texture measurements. This involves a measurement day 1 and day 14 (last day as the method is destructive). The texture of cucumbers will change with storage time. It should be understood that finally the texture has changed so much that the consumer is no longer willing to purchase a product with deteriorated texture. The perception of texture is however subjective, but with texture analysis it is possible to measure the textural parameters in a scientific way and compare them to each other. The texture analyzer (TA.XTplusC) utilizes a probe that is descended towards the object that is to be measured, punctures it, and then is ascended again. The software will then generate values of different textural parameters, such as:
   Skin elasticity. Here it may be noted that with time the skin of the cucumber will become tougher and more difficult to chew.
   Flesh firmness. As the cucumber is losing water over time, the flesh will become more compact and thereby the firmness will increase.
   Stiffness. With time and water loss, the cucumber will lose stiffness and become softer.

It should be noted that the method used for texture analysis is not an official method. The method used is a method available in the Application Studies section on the Exponent Connect Software called “Firmness or “bioyield point” measurement of pears by probing”. After trying different methods used in different papers, the method used was adapted by Fan et al. 2019 for test speeds. Available at: Fan, K., Zhang, M., Fan, D. and Jiang, F., 2019. Effect of carbon dots with chitosan coating on microorganisms and storage quality of modified-atmosphere-packaged fresh-cut cucumber. Journal of the Science of Food and Agriculture, 99(13), pp. 6032-6041.
Dim. This involves a measurement of the surface area between the cucumber skin and core. The surface to volume ratio of a cucumber will impact how much water it will lose. A long and thin cucumber will lose more weight during a given time of storage compared to a short and thick cucumber that weighs the same. This is because the long and thin cucumber has a larger surface area exposed to the air which means a larger area that water can be evaporated from. To approximate the surface area, the length and diameter of the cucumber is measured. The surface area is then calculated by using the assumption that the cucumber is a cylinder.
TSS (total soluble solids). This involves a measurement of sugar content in %. °Brix can be used as a good indicator of ripening in some fruits and vegetables. With time, starch will be degraded to sugars, which will result in a higher Brix value. However, cucumbers do not contain much starch, so the difference is not very evident. To measure TSS, the cucumber is blended to a slurry and filtered through a filter paper. A few drops of the filtered liquid are pipetted on a refractometer that measures TSS.

The method used for TSS with the refractometer PAL-a (Digital Hand-held “pocket refractometer” by Atago, Japan) was adapted from the 920.151 AOAC method “Solids (Total) in Fruits and Fruit Products”, where the fruits are processed into juice, filtered and a few droplets are placed on the refractometer for reading. Reference can be made to ISO 2173: 1978 (revised by ISO 2173: 2003).

The process is as follows:

### Digital Refractometer Atago Brix 0 to 85 (NFC Refractometer) is Used

### 1. Sample Preparation:

During the sample preparation, a whole cucumber is thoroughly blended to achieve uniformity. The resulting mixture is then meticulously filtered using a folded standard paper filter (Fisher Scientific, 250 mm). This filtration step eliminates solid particles and guarantees a consistent liquid sample primed for accurate TSS measurement.

### 2. Calibration:

Before using the refractometer, it was calibrated using distilled water to zero point to ensure accurate readings.

### 3. Measurement and Reading:

A few drops of the juice sample after filtration (6-7 droplets) were placed onto the glass prism of the refractometer. Then instrument provides the instant numerical readings.

### Results

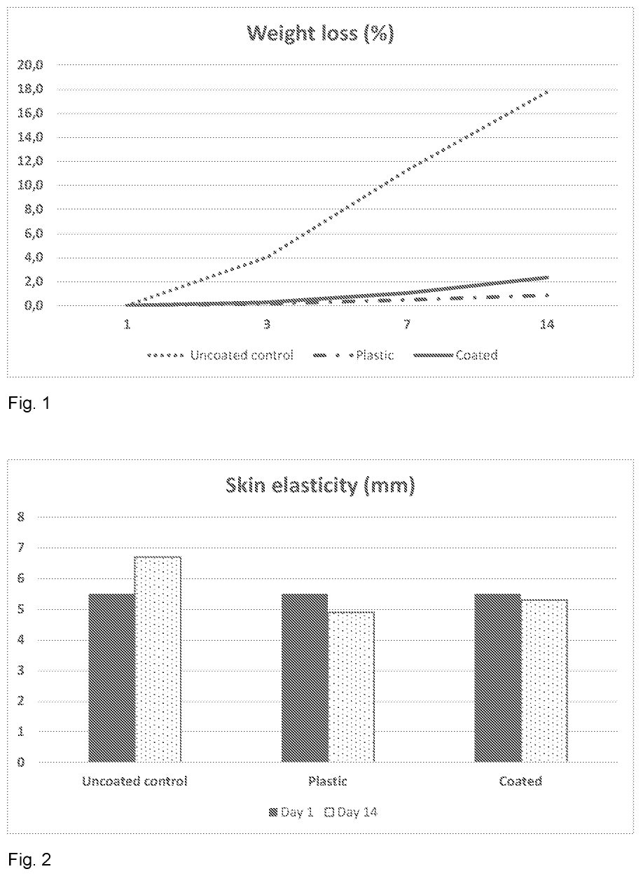

Results at 12° C., RH 60% are presented in FIGS. 1-6 and tables 1-6. Weight loss. One comparative trial has been made with cucumbers and are presented in FIG. 1 and table 1 below. As may be seen, uncoated control and plastic (mentioned above) are compared with “coated”, which is coated with a coating according to the present invention. As may be seen in FIG. 1, the “coated” according to the present invention is more or less comparable with the one having a plastic cover in terms of weight loss. Moreover, as notable, the coated according to the present invention exhibits a much lower weight loss than the uncoated control.

TABLE 1
Weight loss

days

| Type | 1 | 3 | 7 | 14 |
|---|---|---|---|---|
| Uncoated control | 0.0 | 4.0 | 11.3 | 17.8 |
| Plastic | 0.0 | 0.2 | 0.5 | 0.9 |
| Coated | 0.0 | 0.3 | 1.0 | 2.3 |

### Texture Measurements

### Skin Elasticity

In table 2 below and FIG. 2, results for uncoated control and plastic covered are compared with coated according to the present invention. As may be seen, coated according to the present invention provides the most similar result at day 14 when compared to the start value (day 1).

TABLE 2
Skin elasticity (mm)

days

| Type | 1 | 14 |
|---|---|---|
| Uncoated control | 5.5 | 6.7 |
| Plastic | 5.5 | 4.9 |
| Coated | 5.5 | 5.3 |

### Flesh Firmness

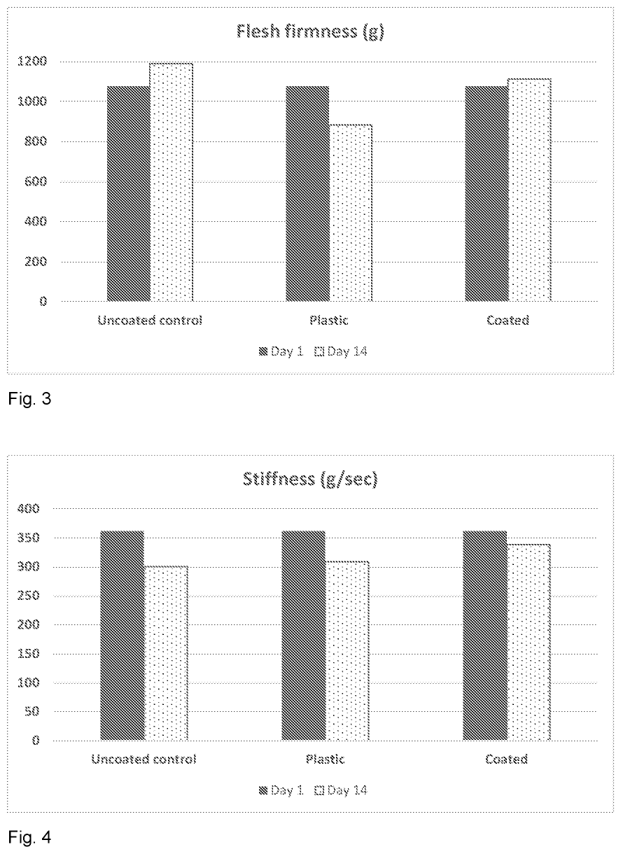

In table 3 below and FIG. 3, comparative results are shown for flesh firmness. In this case a good result is if the value at day 14 is similar to the value at day 1. As can be seen, the coating according to the present invention (“coated”) exhibits the value with the smallest change in this regard.

TABLE 3
Flesh firmness (g)

days

| Type | 1 | 14 |
|---|---|---|
| Uncoated control | 1077 | 1190 |
| Plastic | 1077 | 884 |
| Coated | 1077 | 1113 |

### Stiffness

In table 4 below and FIG. 4, comparative results are shown for stiffness. As may be seen, the coated according to the present invention is the one most similar at day 14 when compared with the start (day 1), which is the direction of interest for the measured value.

TABLE 4
Stiffness (g/s)

days

| Type | 1 | 14 |
|---|---|---|
| Uncoated control | 361.6 | 300.5 |
| Plastic | 361.6 | 309.1 |
| Coated | 361.6 | 338.8 |

### Dim—Flesh Area

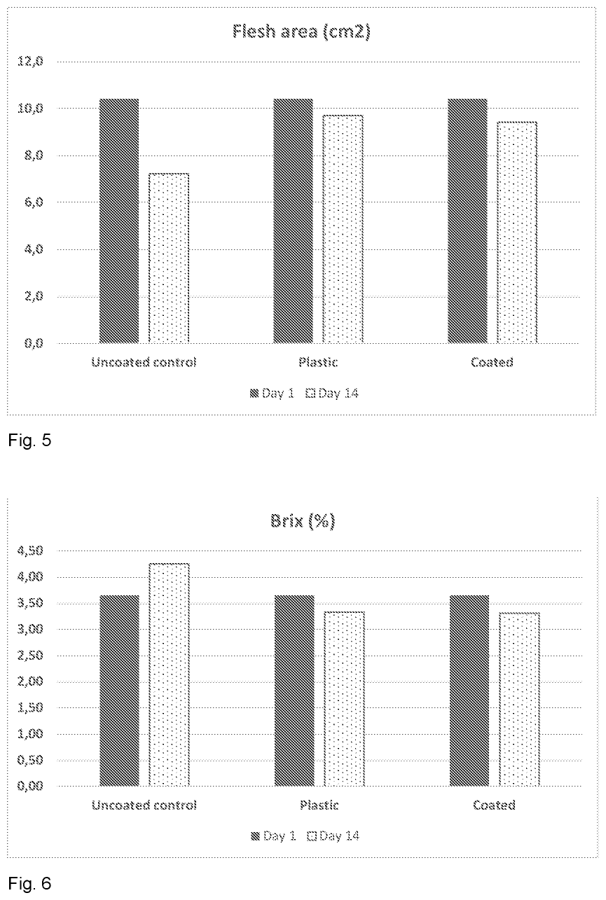

Comparative results are provided below in table 5 and FIG. 5. Also here the best type of result at day 14 is a result similar to the measured value at day 1. The coating according to the present invention provides a strong result, similar to the one coated with the plastic material and clearly better than the uncoated control.

TABLE 5
Dim - flesh area (cm²)

days

| Type | 1 | 14 |
|---|---|---|
| Uncoated control | 10.4 | 7.2 |
| Plastic | 10.4 | 9.7 |
| Coated | 10.4 | 9.4 |

### TSS (Total Soluble Solids) (° Brix)

Comparative results are provided below in table 6 and FIG. 6. Also here a value at day 14 close to the one at day 1 exhibits a good result. As may be seen the coating according to the present invention provides a strong result, similar to the one coated with the plastic material and clearly better than the uncoated control.

TABLE 6
TSS (Total Soluble Solids) (°Brix)

days

| Type | 1 | 14 |
|---|---|---|
| Uncoated control | 3.65 | 4.25 |
| Plastic | 3.65 | 3.33 |
| Coated | 3.65 | 3.31 |

1. A coating composition intended for coating of foodstuffs, wherein the coating composition comprises at least one saturated lipid component and an emulsifying agent, and wherein the emulsifying agent comprises oat oil or a derivative of oat oil.

2. The coating composition according to claim 1, wherein the coating composition comprises
at least one saturated lipid component chosen from C8:0-C18:0; and
an emulsifying agent comprising oat oil or a derivative of oat oil.

3. The coating composition according to claim 1, wherein the foodstuff is a vegetable or fruit.

4. The coating composition according to claim 1, wherein the coating composition comprises at least 50 wt. % of saturated fatty acids, monoglycerides, diglycerides and/or triglycerides from C8:0-C18:0, or a combination thereof, measured of the total weight of the lipid content, preferably at least 65 wt. %, more preferably at least 80 wt. % of saturated fatty acids, monoglycerides, diglycerides and/or triglycerides from C8:0-C18:0, or a combination thereof, measured of the total weight of the lipid content.

5. The coating composition according to claim 1, wherein said at least one saturated lipid component is a hydrogenated prior unsaturated lipid component, preferably a hydrogenated prior unsaturated lipid component chosen from C8:0-C18:0.

6. The coating composition according to claim 1, wherein the coating composition comprises at least 50 wt. % saturated fatty acids from C16:0-C18:0, preferably at least 80 wt. %, measured of the total weight of the lipid content.

7. The coating composition according to claim 1, wherein the coating composition comprises at least 50 wt. % saturated fatty acids from C18:0, preferably at least 80 wt. %, measured of the total weight of the lipid content.

8. The composition according to claim 1, wherein the composition comprises a dry matter level in a range of 10-50%.

9. The composition according to claim 1, wherein the composition comprises oat oil or a derivative of oat oil in a range of 1-25 wt. %, preferably in a range of 1-20 wt. %, more preferably in a range of 1.5-14 wt. %, more preferably in a range of 2-10 wt. %.

10. The coating composition according to claim 1, wherein the lipid component is based on saturated rapeseed oil, preferably fully hydrogenated rapeseed oil.

11. The coating composition according to claim 1, wherein the lipid content is at least 15 wt. % of the coating composition and wherein the coating composition contains maximum 80 wt. % water.

12. The coating composition according to claim 1, wherein the lipid content is at least 20 wt. % of the coating composition, preferably at least 25 wt. % of the coating composition, more preferably at least 30 wt. % of the coating composition, preferably the coating composition contains maximum 75 wt. % water, more preferably the coating composition contains maximum 70 wt. % water, more preferably the coating composition contains maximum 65 wt. % water, more preferably the coating composition contains maximum 60 wt. % water, most preferably the coating composition contains maximum 55 wt. % water.

13. The coating composition according to claim 1, wherein the coating composition comprises an edible wax component, preferably the edible wax component is carnauba wax, beeswax, candelilla wax, canola wax, shellac or a microcrystalline wax component, or a combination thereof, preferably in a range of 5-60 wt. %, more preferably in a range of 10-60 wt. %, more preferably in a range of 5-40 wt. %, more preferably in a range of 10-40 wt. %, more preferably in a range of 15-30 wt. %,
and/or wherein the coating composition comprises at least one edible polysaccharide, cellulose or a protein,
and/or wherein the coating composition also comprises at least one resin component, gum component, rubber component, and/or polymer component, such as a hydrocolloid polymer, or a combination thereof.

14. (canceled)

15. (canceled)

16. (canceled)

17. The coating composition according to claim 1, wherein the coating composition comprises a fermented component, preferably a lactic fermented component, more preferably a fermented cucumber juice.

18. The coating according to claim 1, in the form of a liquid, semi-liquid, spray or dipping.

19. A foodstuff, preferably a vegetable or fruit, coated with a coating composition according to claim 1.

20. The foodstuff according to claim 19, wherein the foodstuff exhibits maximum 6% weight loss, preferably maximum 3% weight loss, more preferably maximum 2% weight loss, when measured after 7 days at room temperature.

21. The foodstuff according to claim 19, wherein the foodstuff is a vegetable or fruit, preferably a vegetable or fruit containing more that 60% water, more preferably a cucumber.

22. The foodstuff according to claim 19, wherein the thickness of the coating composition is in a range of 0.01-30 μm.

23. A method involving producing a coating composition according to claim 1, said method comprising
mixing components;
heating the mixture, preferably to a temperature of at least 40° C.; and
dispersing,
preferably the method involves applying a coating composition according to claim 1 onto the surface of the foodstuff at a temperature in a range of 0-40° C. to provide a coated foodstuff and then drying the coated foodstuff.

24. (canceled)
